(19) United States
(12) Patent Application Publication
(10) Pub. No.: US 2014/0302393 A1
(43) Pub. Date: Oct. 9, 2014

(54) HIGH CAPACITY LITHIUM-ION ELECTROCHEMICAL CELLS AND METHODS OF MAKING SAME

(71) Applicant: 3M INNOVATIVE PROPERTIES COMPANY, St. Paul, MN (US)

(72) Inventors: Leif Christensen, St. Paul, MN (US); Kevin W. Eberman, St. Paul, MN (US)

(21) Appl. No.: 14/353,791

(22) PCT Filed: Oct. 25, 2012
(86) PCT No.: PCT/US12/61781

§ 371 Date: Apr. 24, 2014

Related U.S. Application Data
(60) Provisional application No. 61/551,642, filed on Oct. 26, 2011.

(51) Int. Cl. H01M 4/36; H01M 10/058; H01M 10/0525; H01M 4/485; H01M 4/525

(52) U.S. Cl. CPC H01M 4/366; H01M 4/485; H01M 4/525; H01M 10/0525; H01M 10/058
USPC 429/223; 429/231.1; 29/623.1

(57) ABSTRACT

High capacity lithium-ion electrochemical cells are provided that include positive electrode comprising a layered lithium transition metal oxide having a first irreversible capacity and a negative electrode that includes an alloy anode material that also has a first irreversible capacity. The first irreversible capacity of the positive electrode is less than the first irreversible capacity of the negative electrode. The discharge voltage curve of the positive electrode covers at least 10% of its capacity at voltages below 3.5 V ea) vs. Li/Li⁺. The average discharge voltage of the positive electrode is above 3.75 V vs. Li/Li⁺ when the cell is discharged from about 4.6 V vs. Li/Li⁺ to about 2.5 V vs. Li/Li⁺ at a rate of C/10 or slower and when the electrochemical cell is discharged to a final discharge voltage of about 2.5 V vs. Li/Li⁺ or greater.

### FIELD

This disclosure relates to high capacity lithium-ion electrochemical cells.

### BACKGROUND

Secondary lithium-ion electrochemical cells typically include a positive electrode that contains lithium in the form of a lithium transition metal oxide (typically layered or spinel-structured), a negative electrode (typically carbon or graphite), and an electrolyte. Examples of transition metal oxides that have been used for positive electrodes include lithium cobalt dioxide (LCO) and lithium nickel dioxide. Other exemplary lithium transition metal oxide materials that have been used for positive electrodes include mixtures of cobalt, nickel, and/or manganese oxides. Most commercial lithium-ion electrochemical cells operate by reversible lithium intercalation and extraction into both the active negative electrode material and the active positive electrode material. Increases in energy density of lithium-ion electrochemical cells have, thus far, mainly been the result of an engineering approach, accomplished by incremental densification of both the negative and positive electrodes, utilizing the same active materials (LCO and graphite) both having low irreversible capacity, rather than through introduction of new, higher capacity materials.

High energy lithium-ion electrochemical cells having high discharge capacity upon cycling are described, for example, in U. S. Pat. App. Publ. No. 2009/0263707 (Buckley et al.). These cells use high capacity positive active materials, graphite or carbon negative active materials, and very thick composite electrode coatings. However, since the active material coatings are thick, mass and charge transport within the electrodes can become impeded, and it is difficult to make wound cells, without the coatings flaking off of the current collector.

Other approaches to increase the energy density of lithium-ion electrochemical cells include the substitution of the negative graphite anode with an active alloy capable of reacting with lithium. Such alloys may include one or more of the following electrochemical active elements—Si, Sn, Al, Ga, Ge, In, Bi, Pb, Zn, Cd, Hg, and Sb, However, the implementation of high energy cells by using alloy anodes have so far been difficult, and lead to poor cycle life. Applicants' copending application, U.S. Ser. No. 61/529,307 (Christensen et al.), entitled “High Capacity Positive Electrodes for Use in Lithium-ion Electrochemical Cells and Methods of Making Same”, filed Aug. 31, 2011 discloses that for electrode stability and long cycle life it is important that the voltage of the composite alloy anode remains below 0.9V vs. Li/Li⁺ during discharge in a full cell. As described in said application, this can be accomplished by ensuring that the composite positive electrode has an equivalent or slightly larger irreversible capacity than the negative composite electrode.

### SUMMARY

As portable electronic devices become smaller, there is a need for more compact, higher energy batteries to power such devices. Furthermore, as lithium-ion battery technology usage is increased for “motive” applications (automobiles, scooters, and bicycles) there are additional needs for high energy, high discharge rate, long cycle life, and lower cost.

In one aspect, a lithium-ion electrochemical cell is provided that includes a positive electrode comprising an active material wherein the positive electrode has a first irreversible capacity, and a negative electrode that includes an alloy anode material having a first irreversible capacity when the anode is delithiated to about 0.9 volts (V) vs. Li/Li⁺, wherein the first irreversible capacity of the positive electrode is less than the first irreversible of the negative electrode, wherein the discharge voltage curve of the positive electrode covers at least 10% of its capacity at voltages below 3.5 V vs. Li/Li⁺, wherein the average discharge voltage of the positive electrode is above 3.75 V vs. Li/Li⁺ when discharged from about 4.8 V vs. Li/Li⁺ to about 2.5 V vs. Li/Li⁺ at a rate of C/10 or slower, and wherein the electrochemical cell is discharged to a final discharge voltage of about 2.5 V vs. Li/Li⁺ or greater. In some embodiments, a blend or mixture of two or more active materials having different individual voltage profiles can be used to make the positive electrode having a first irreversible capacity or the negative electrode having a first irreversible capacity. In other embodiments, the positive electrode can include composite particles that comprise a core comprising a layered lithium metal oxide having an O3 crystal structure, wherein if the layered lithium metal oxide is incorporated into a cathode of a lithium-ion cell, and the lithium-ion cell is charged to at least 4.6 V vs. Li/Li⁺ and then discharged, the layered lithium metal oxide exhibits no dQ/dV peaks below 3.5 V vs. Li/Li⁺, and wherein the core comprises from 30 mole percent to 85 mole percent of the composite particle, based on the total moles of atoms of the composite particle, and a shell layer having an O3 crystal structure substantially surrounding the core, wherein the shell layer comprises an oxygen-loss, layered lithium metal oxide.

In another aspect, a method of making a lithium-ion electrochemical cell is provided that includes selecting a positive electrode having a first irreversible capacity. The positive electrode includes composite particles that comprise a core comprising a layered lithium metal oxide having an O3 crystal structure, wherein if the layered lithium metal oxide is incorporated into a cathode of a lithium-ion cell, and the lithium-ion cell is charged to at least 4.6 V vs. Li/Li⁺ and then discharged, the layered lithium metal oxide exhibits no dQ/dV peaks below 3.5 V vs. Li/Li⁺. The core comprises from 30 mole percent to 85 mole percent of the composite particle, based on the total moles of atoms of the composite particle. The composite particles also include a shell layer having an O3 crystal structure substantially surrounding the core, wherein the shell layer comprises an oxygen-loss, layered lithium metal oxide. The method further includes selecting a negative electrode that includes an alloy anode that has a first cycle irreversible capacity when delithiated to 0.9 V vs. Li/Li⁺ and constructing a lithium-ion electrochemical cell using an electrolyte, positive electrode and negative electrode. The first irreversible capacity of the positive electrode is less than the first irreversible of the negative electrode, the discharge voltage curve of the positive electrode covers at least 10% of its capacity at voltages below 3.5 V vs. Li/Li⁺ when cycled in a half cell against a metallic lithium counter electrode at a rate of C/10 or slower keeping the average discharge voltage of the positive electrode above 3.75 V vs. Li/Li⁺ when the half cell is discharged between 4.8 V vs. Li/Li⁺ and 2.5 V vs. Li/Li⁺, and the electrochemical cell is charged to a final discharge voltage of 2.5 V vs. Li/Li⁺ or greater.

In the present disclosure:

“active” or “electrochemically active” refers to a material that can undergo lithiation and delithiation by reaction with lithium;

“inactive” or “electrochemical inactive” refers to a material that does not react with lithium and does not undergo lithiation and delithiation;

“alloy active material” refers to a composition of two or more elements, at least one of which is a metal, and where the resulting material is electrochemically active;

“substantially surrounding” refers to a shell that almost completely surrounds the core, but may have some imperfections which expose very small portions of the core such as, for example, pinholes or small cracks;

“composite (positive or negative) electrode” refers to the active and inactive material that make up the coating that is applied to the current collector to form the electrode and includes, for example, conductive diluents, adhesion-promoters, and binding agents;

“composite particle” refers to a particle composed of at least two distinct phases like a core and a shell;

“cycling” refers to lithiation followed by delithiation or vice versa;

“dQ/dV” refers to the rate of change of capacity with respect to cell voltage (that is, differential capacity versus cell voltage);

“first irreversible capacity” is the total amount of lithium capacity of an electrode that is lost during the first charge/discharge cycle which is expressed in mAh, or as a percentage of the total electrode;

“lithium mixed metal oxide” refers to a lithium metal oxide composition that includes one or more transition metals in the form of an oxide;

“negative electrode” refers to an electrode (often called an anode) where electrochemical oxidation and delithiation occurs during a discharging process;

“O3 crystal structure” refers to a crystal structure in which oxygen planes are stacked ABCABC and lithium occupies octahedral sites; and

“positive electrode” refers to an electrode (often called a cathode) where electrochemical reduction and lithiation occurs during a discharging process.

The provided lithium-ion electrochemical cells meet the need for electrochemical cells that have high capacity and long cycle life. The provided electrochemical cells can have higher energy density than conventional lithium-ion electrochemical cells so that they are useful for powering advanced portable electronics, and various “motive” applications. The provided lithium-ion electrochemical cells can have much longer cycle life without significant loss of energy than conventional cells.

The above summary is not intended to describe each disclosed embodiment of every implementation of the present invention. The brief description of the drawings and the detailed description which follows more particularly exemplify illustrative embodiments.

### BRIEF DESCRIPTION OF THE DRAWINGS

FIG. 1 is a schematic cross-sectional side view of an exemplary composite particle according to the present disclosure.

FIG. 2 is a schematic cross-sectional side view of an exemplary cathode according to the present disclosure.

FIG. 3 is an exploded perspective schematic view of an exemplary lithium-ion electrochemical cell according to the present disclosure.

FIG. 4 is a composite plot of cathode capacity (mAh/g) vs. cell voltage (V) and anode capacity (mAh/g) vs. cell voltage (V) for an exemplary electrochemical cell.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Lithium-ion electrochemical cells are provided that include positive electrode comprising a layered lithium transition metal oxide having a first irreversible capacity and a negative electrode that includes an alloy anode material having a first irreversible capacity when the anode is delithiated to 0.9 V vs. Li/Li⁺. The first irreversible capacity of the positive electrode is less than the first irreversible capacity of the negative electrode. Useful layered lithium transition metal oxides include “lithium-rich” or “oxygen-loss”. “Excess lithium” or “lithium-rich” layered materials (also known in the art as “oxygen-loss” materials) (for example, see Lu et al. in Journal of The Electrochemical Society, 149 (6), A778-A791 (2002), and Arunkumar et al. in Chemistry of Materials., 19, 3067-3073 (2007)) such as, for example, Li[Li_{0.06}Mn_{0.525}Ni_{0.415}]O₂, Li[Li_{0.02}Mn_{0.54}Ni_{0.13}Co_{0.13}]O₂, and Li[Li_{0.2}Mn_{0.6}Ni_{0.2}]O₂ may exhibit capacities of as high as 265 mAh/g at low discharge rates (for example, see Gao et al. in Journal of Power Sources, 191, 644-647 (2009)). However, lithium-rich layered materials typically can have low average discharge voltages (less than 3.7 V) when recorded in a half cell against a metallic lithium counter electrode at a C/10 rate leading to a significant reduction in the cell energy capacity. In some embodiments, the oxygen-loss layered transition metal oxide can comprises lithium, nickel, manganese, and cobalt in an amount allowing the total cobalt content of the composite metal oxide to be less than 20 mole percent. Examples include, but are not limited to, solid solutions of Li[Ni_{2/3}Mn_{1/3}]O₂ and Li[NiₓMn_{y}Co_{z}]O₂, wherein 0≦x≦1, 0≦y≦1, 0≦z≦0.2, and wherein x+y+z=1, and the average oxidation state of the transition metals is three.

Other examples of layered lithium metal oxides include, but are not limited to LiCoO₂, Li[Ni_{0.80}, Al_{0.05}Co_{0.15}]O₂, Li[Li_{w}NiₓMn_{y}Co₂Mₚ]O₂ wherein M is a metal other than Li, Ni, Mn, or Co; 0<w<1/3; 0≦x≦1; 0≦y≦2/3; 0≦z≦1; 0<p<0.15; w+x+y+z+p=1; and the average oxidation state of the metals within the brackets is three, including Li[Ni_{0.5}Mn_{0.5}]O₂ and Li[Ni_{2/3}Mn_{1/3}]O₂. X-ray diffraction (XRD), well-known in the art, can be used to ascertain whether or not the material has a layered structure.

The discharge voltage curve of the provided positive electrodes cover at least 10% of the capacity of the electrode at voltages below 3.5 V vs. Li/Li⁺. In the provided electrochemical cells, the “average discharge voltage” of the positive electrode is above 3.75 V vs. Li/Li⁺ when discharged from about 4.6 V vs. Li/Li⁺ to about 2.5 V vs. Li/Li⁺ when discharged at a rate of C/10 or slower and wherein the electrochemical cell is discharged to a final discharge voltage of about 2.5 V vs. Li/Li⁺ or greater.

The “average discharge voltage”, Vₐᵥₑ (D), for a positive electrode is determined in the following fashion. The positive electrode is discharged from 4.8 V vs. Li/Li⁺ to 2.5 V vs. Li/Li⁺ at a rate of C/10 in a coin cell half cell against a metallic Li counter electrode. From a plot of electrode voltage versus capacity the discharge energy E(Wh) (integrated area under the voltage curve) and the discharge capacity Q(Ah) is determined. The average discharge voltage is determined from the equation:

Vₐᵥₑ(D)=E/Q

In some embodiments, high capacity lithium-ion electrochemical cells are provided that include a positive electrode comprising composite particles having a first irreversible capacity. The composite particles include a core comprising a layered lithium metal oxide having an O3 crystal structure and a shell layer having an O3 crystal structure substantially surrounding the core, the shell layer comprising an oxygen-loss, layered lithium metal oxide. Exemplary composite particles are disclosed, for example, in provisional patent application, U.S. Ser. No. 61/444,247 (Christensen), filed Feb. 28, 2011, and entitled “Composite Particles, Methods of Making the Same, and Articles Including the Same”. If the electrode that includes composite particles comprising layered lithium metal oxide is incorporated into a cathode of a lithium-ion cell, and the lithium-ion cell is charged to at least 4.6 V versus Li/Li⁺ and then discharged, then the layered lithium metal oxide exhibits no dQ/dV peaks below 3.5 V vs. Li/Li⁺. Generally, such materials have a molar ratio of Mn:Ni, if both Mn and Ni are present, that is less than or equal to one.

Certain lithium transition metal oxides do not readily accept significant additional amount of excess lithium, do not display a well-characterized oxygen-loss plateau when charged to a voltage above 4.6 V vs. Li/Li⁺, and on discharge do not display a reduction peak below 3.5 V vs. Li/Li⁺ in a graph of dQ/dV. Examples include Li[Ni_{2/3}Mn_{1/3}]O₂, Li[Ni_{0.42}Mn_{0.42}Co_{0.16}]O₂, and Li[Ni_{0.5}Mn_{0.5}]O₂. Such oxides are particularly useful as core materials.

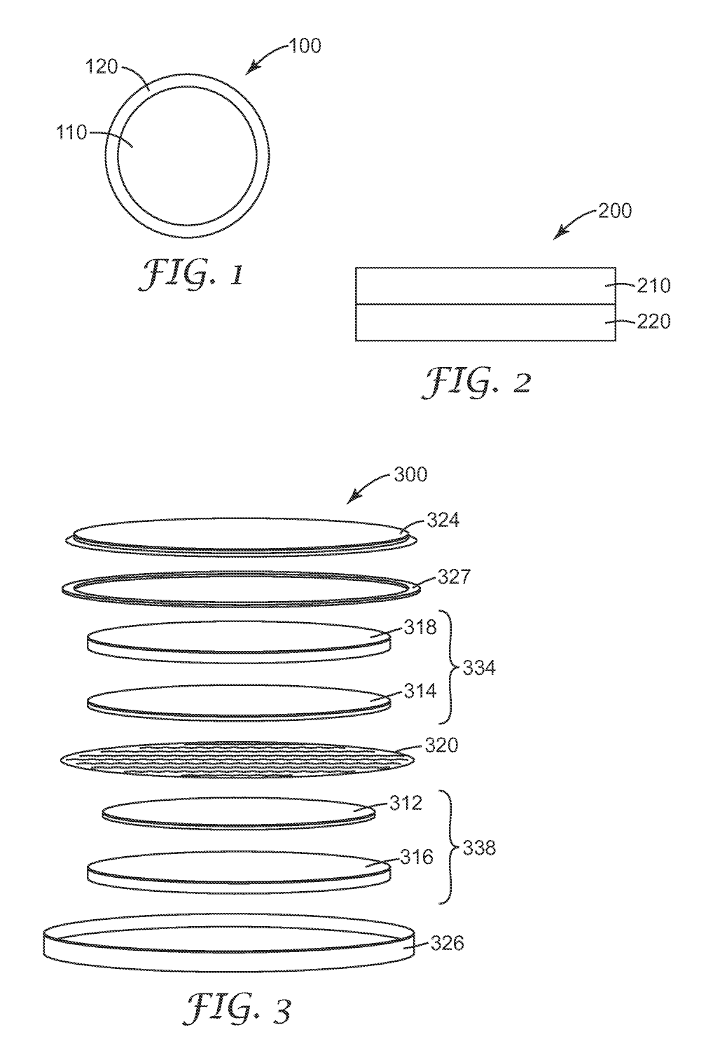

FIG. 1 is a schematic cross-sectional side view of an exemplary composite particle. Core 110 comprises from 30mole percent to 85 mole percent of the composite particle. In some embodiments, core 110 comprises from 50 mole percent to 85 mole percent, or from 60 mole percent to 80 mole percent or 85 mole percent, of the composite particle, based on the total moles of atoms of the composite particle. Shell layer 120 comprises an oxygen-loss, layered lithium metal oxide having an O3 crystal structure configuration. In some embodiments, the oxygen-loss layered metal oxide comprises lithium, nickel, manganese, and cobalt in an amount allowing the total cobalt content of the composite metal oxide to be less than 20 mole percent. Examples include, but are not limited to, solid solutions of Li[Li_{1/3}Mn_{2/3}]O₂ and Li[NiₓMn_{y}Co_{z}]O₂, wherein 0≦x≦1, 0≦y≦1, 0≦z≦0.2, and wherein x+y+z=1, and the average oxidation state of the transition metals is three, excluding the materials listed above under the core material definition that do not show particular strong oxygen loss characteristics. Particularly useful shell materials include, for example, Li[Li_{0.02}Mn_{0.54}Ni_{0.13}Co_{0.13}]O₂ and Li[Li_{0.06}Mn_{0.525}Ni_{0.415}]O₂ as well as additional materials described in Lu et al. in Journal of The Electrochemical Society, 149 (6), A778-A791 (2002), and Arunkumar et al. in Chemistry of Materials, 19, 3067-3073 (2007). Generally, such materials have a molar ratio Mn:Ni, if both present, greater than one.

Shell layer 120 comprises from 15 mole percent to 70 mole percent of the composite particle. In some embodiments, shell layer 120 comprises from 15 mole percent to 50 mole percent, or from 15 mole percent or 20 mole percent to 40 mole percent of the composite particle, based on the total moles of atoms of the composite particle. The shell layer may have any thickness subject to the restrictions on composition of the composite particle described above. In some embodiments, the thickness of the shell layer is in a range of from 0.5 to 20 micrometers.

Composite particles according to the present disclosure may have any size, but desirably have an average particle diameter in a range of from 1 to 25 micrometers. In some embodiments, the charge capacity of the composite particle is greater than the charge capacity of the core. This is typically desirable, but it is not a requirement. The composite particles can have a density of greater than or equal to 2.8 g/cubic centimeters.

Composite particles according to the present disclosure can be made by various methods. In one method, core precursor particles comprising a first metal salt are formed, and used as seed particles for the shell layer, which comprises a second metal salt deposited on at least some of the core precursor particles to provide composite particle precursor particles. In this method, the first and second metal salts are different. The composite particle precursor particles are dried to provide dried composite particle precursor particles, which are combined with a lithium source material to provide a powder mixture. The powder mixture is then fired (that is, heated to a temperature sufficient to oxidize the powder in air or oxygen) to provide composite lithium metal oxide particles according to the present disclosure.

For example, a core precursor particle, and then a composite particle precursor, may be formed by stepwise (co)precipitation of one or more metal oxide precursors of a desired composition (first to form the core and then to form the shell layer) using stoichiometric amounts of water-soluble salts of the metal(s) desired in the final composition (excluding lithium and oxygen) and dissolving these salts in an aqueous solution. As examples, sulfate, nitrate, oxalate, acetate and halide salts of metals can be utilized. Exemplary sulfate salts useful as metal oxide precursors include manganese sulfate, nickel sulfate, and cobalt sulfate. The precipitation is accomplished by slowly adding the aqueous solution to a heated, stirred tank reactor under inert atmosphere, together with a solution of sodium hydroxide or sodium carbonate. The addition of the base is carefully controlled to maintain a constant pH. Ammonium hydroxide additionally may be added as a chelating agent to control the morphology of the precipitated particles, as will be known by those of ordinary skill in the art. The resulting metal hydroxide or carbonate precipitate can be filtered, washed, and dried thoroughly to form a powder. To this powder can be added lithium carbonate or lithium hydroxide to form a mixture. The mixture can be sintered, for example, by heating it to a temperature of from 500° C. to 750° C. for a period of time from between one and 10 hours. The mixture can then be oxidized by firing in air or oxygen to a temperature from 700° C. to above about 1000° C. for an additional period of time until a stable composition is formed. This method is disclosed, for example, in U. S. Pat. Appl. Publ. No. 2004/0179993 (Dahn et al.), and is known to those of ordinary skill in the art.

In a second method, a shell layer comprising a metal salt is deposited on at least some of preformed core particles comprising a layered lithium metal oxide to provide composite particle precursor particles. The composite particle precursor particles are then dried to provide dried composite particle precursor particles, which are combined with a lithium-ion source material to provide a powder mixture. The powder mixture is then fired in air or oxygen to provide composite particles according to the present disclosure.

The provided lithium-ion electrochemical cells also include a negative electrode that includes an alloy anode material having a first irreversible capacity when the anode is delithiated to 0.9 V vs. Li/Li⁺. Useful alloy active materials include silicon, tin, aluminum, or a combination thereof. Additionally, the alloys can include inactive elements including at least one transition metal. Suitable transition metals include, but are not limited to, titanium, vanadium, chromium, manganese, iron, cobalt, nickel, copper, zirconium, niobium, molybdenum, tungsten, and combinations thereof The alloy materials can also, optionally, include elements such as indium, carbon, or one or more of yttrium, a lanthanide element, an actinide element or combinations thereof. Suitable lanthanide elements include lanthanum, cerium, praseodymium, neodymium, promethium, samarium, europium, gadolinium, terbium, dysprosium, holmium, erbium, thulium, ytterbium, and lutetium.

Typical alloy active materials can include greater than 55 mole percent silicon. They can also include transition metals selected from titanium, cobalt, iron, and combinations thereof. Useful alloy active materials can be selected from materials that have the following components, SiAlFeTiSnMm, SiFeSn, SiAlFe, SnCoC, and combinations thereof where “Mm” refers to a mischmetal that comprises lanthanide elements. Exemplary active alloy materials include Si₆₀Al₁₄Fe₈TiSn₇Mm₁₀, Si₇₁Fe₂₅Sn₄, Si₅₇Al₂₈Fe₁₅, Sn₃₀Co₃₀C₄₀, or combinations thereof. The active alloy materials can be a mixture of an amorphous phase that includes silicon and a nanocrystalline phase that includes an intermetallic compound that comprises tin. Exemplary alloy active materials useful in the provided lithium-ion electrochemical cells can be found, for example, in U.S. Pat. No. 6,680,145 (Obrovac et al.), U.S. Pat. No. 6,699,336 (Turner et al.), and U.S. Pat. No. 7,498,100 (Christensen et al.) as well as in U.S. Pat. No. 7,906,238 (Le), U.S. Pat. Nos. 7,732,095 and 7,972,727 (both Christensen et al.), U.S. Pat. No. 7,871,727, and U.S. Pat. No. 7,767,349 (both Obrovac et al.).

The first irreversible capacity of the positive electrode is less than the first irreversible of the negative electrode. The discharge voltage curve of the positive electrode covers at least 10% of its capacity at voltages below 3.5 V vs. Li/Li⁺, when recorded in a half cell against a metallic lithium counter electrode at a rate of C/10 or slower. The average discharge voltage of the positive electrode is greater than 3.75 V vs. Li/Li⁺, when discharged from 4.8 V vs. Li/Li⁺ to 2.5 V vs. Li/Li⁺, and the electrochemical cell is discharged to a final discharge voltage of 2.5 V vs. Li/Li⁺ or greater.

Certain lithium transition metal oxides do not readily accept significant additional amount of excess lithium, do not display a well-characterized oxygen-loss plateau when charged to a voltage above 4.6 V vs. Li/Li⁺, and on discharge do not display a reduction peak below 3.5 V vs. Li/Li⁺ in dQ/dV. Examples include Li[Ni_{2/3}Mn_{1/3}]O₂, Li[Ni_{0.42}Mn_{0.42}Co_{0.16}]O₂, and Li[Ni_{0.5}Mn_{0.5}]O₂. Such oxides are particularly useful as core materials.

The provided lithium-ion electrochemical cells also include a negative electrode that includes an alloy anode material having a first irreversible capacity when the anode is delithiated to 0.9 V vs. Li/Li⁺. The first irreversible capacity of the positive electrode is less than the first irreversible of the negative electrode. The discharge voltage curve of the positive electrode covers at least 10% of its capacity at voltages below 3.5 V vs. Li/Li⁺, when the positive electrode is cycled in a half cell against a metallic lithium counter electrode, discharged at a rate of C/10 or slower, and displaying a average discharge voltage above 3.75 V vs. Li/Li⁺ when discharged between 4.8 V, and the electrochemical cell is charged to a final discharge voltage of 2.5 V vs. Li/Li⁺ or greater.

Composite particles according to the present disclosure are useful, for example, in manufacture of cathodes for lithium-ion batteries. Referring now to FIG. 2, exemplary cathode 200 comprises cathode composition 210 disposed on current collector 220. Cathode composition 210 comprises composite particles according to the present disclosure, at least one conductive diluent, and a binder. Examples of suitable conductive diluents include: carbon blacks such as those available as “SUPER P” and “SUPER S” from MMM Carbon, Belgium; those available as Shawinigan Black from Chevron Chemical Co., Houston, Tex.; acetylene black, furnace black, graphite, and carbon fibers. Metal particles, conductive metal nitrides, and conductive metal carbides may also be used. Combinations of two or more conductive diluents may be used.

Exemplary suitable binders include polyolefins such as those prepared from ethylene, propylene, or butylene monomers; fluorinated polyolefins such as those prepared from vinylidene fluoride monomers; perfluorinated polyolefins such as those prepared from hexafluoropropylene monomer; perfluorinated poly(alkyl vinyl ethers); perfluorinated poly(alkoxyvinyl ethers); alkali metal polyacrylates such as lithium polyacrylate; aromatic, aliphatic, or cycloaliphatic polyimides, or combinations thereof. Specific examples of suitable binders include polymers or copolymers of vinylidene fluoride, tetrafluoroethylene, and propylene; and copolymers of vinylidene fluoride, and hexafluoropropylene.

Suitable electrolytes can be in the form of a solid, liquid, or gel. Exemplary solid electrolytes include polymers such as polyethylene oxide, polytetrafluoroethylene, polyvinylidene difluoride, fluorine-containing copolymers, polyacrylonitrile, and combinations thereof. Examples of liquid electrolytes include ethylene carbonate, propylene carbonate, dimethyl carbonate, diethyl carbonate, ethyl-methyl carbonate, butylene carbonate, vinylene carbonate, fluoroethylene carbonate, fluoropropylene carbonate, gamma-butylrolactone, methyl difluoroacetate, ethyl difluoroacetate, dimethoxyethane, diglyme (that is, bis(2-methoxyethyl) ether), tetrahydrofuran, dioxolane, combinations thereof and other media that will be familiar to those skilled in the art. The electrolyte can be provided with a lithium electrolyte salt. Exemplary lithium salts include LiPF₆, LiBF₄, LiClO₄, lithium bis(oxalato)borate, LiN(CF₃SO₂)₂, LiN(C₂F₅SO₂)₂, LiAsF₆, LiC(CF₃SO₂)₃, and combinations thereof. Exemplary electrolyte gels include those described in U.S. Pat. No. 6,387,570 (Nakamura et al.) and U.S. Pat. No. 6,780,544 (Noh). The electrolyte can include other additives that will be familiar to those skilled in the art. For example, the electrolyte can contain a redox chemical shuttle such as those described in U.S. Pat. No. 5,709,968 (Shimizu), U.S. Pat. No. 5,763,119 (Adachi), U.S. Pat. No. 5,536,599 (Alamgir et al.), U.S. Pat. No. 5,858,573 (Abraham et al.), U.S. Pat. No. 5,882,812 (Visco et al.), U.S. Pat. No. 6,004,698 (Richardson et al.), U.S. Pat. No. 6,045,952 (Kerr et al.), and U.S. Pat. No. 6,387,571 (Lain et al.); and in U.S. Pat. Nos. 7,648,801; 7,811,710; and 7,615,312 (all to Dahn et al.).

In some embodiments, lithium-ion electrochemical cells according to the present disclosure can take the form of, for example, 2325 coin cells as is known in the art. Referring now to FIG. 3, a 2325 coin-type electrochemical cell 300 includes stainless steel cap 324 and oxidation resistant case 326 enclosing the cell and serving as negative and positive terminals, respectively. Anode 334 is formed from anode composition 314 disposed on current collector 318. Cathode 338 includes cathode composition 312 disposed on current collector 316. Separator 320, which separates the anode and cathode is wetted with electrolyte (not shown). Typically, a microporous separator, such as CELGARD 2400 microporous material, available from Celgard LLC, Charlotte, N.C., can be used as the separator.

The provided lithium-ion electrochemical cells include a negative electrode that includes an alloy anode material having a first irreversible capacity when the anode is delithiated to 0.9 V vs. Li/Li⁺. the first irreversible capacity of the positive electrode is less than the first irreversible of the negative electrode. The discharge voltage curve of the positive electrode covers at least 10% of its capacity at voltages below 3.5 V vs. Li/Li⁺, when recorded in a half cell against a metallic lithium counter electrode at a rate of C/10 or slower. The provided lithium-ion electrochemical cells display an average discharge voltage above 3.75 V vs. Li/Li⁺ when discharged between 4.8 V vs. Li/Li⁺ and 2.5 V vs. Li/Li⁺. The electrochemical cells are discharged to a final discharge voltage of 2.5 V vs. Li/Li⁺ or greater.

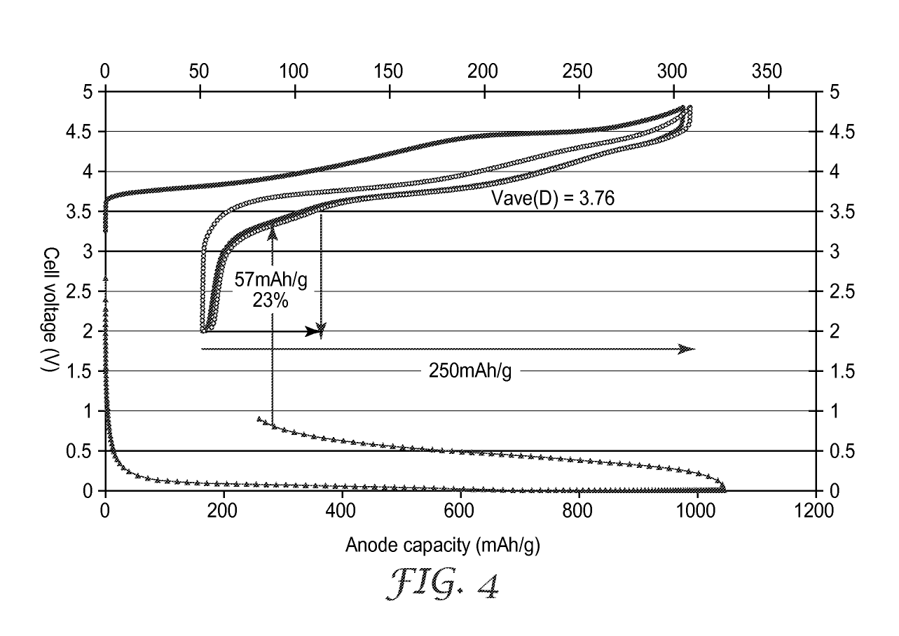

FIG. 4 is a composite plot of cathode capacity (mAh/g) vs. cell voltage (V) and anode capacity (mAh/g) vs. cell voltage (V) for an exemplary electrochemical cell. The exemplary electrochemical cell includes a negative electrode that comprises an alloy anode material (Si₇₁Fe₂₅Sn₄) and a core/shell positive electrode, Li_{1.2}({[Ni_{2/3}Mn_{1/3}]_{0.70[Ni}_{1/4}Mn_{3/4}]_{0.30}}_{0.8})O₂, that has a core that has Ni_{2/3}Mn_{1/3} surrounded by a shell that has Ni_{1/4}Mn_{3/4}.

The irreversible first cycle capacity loss for the positive electrode (50 mAh/g divided by 310 mAh/g=16%) is less than the first cycle irreversible capacity loss of the negative electrode (about 240 mAh/g divided by 1050 mAh/g 32 23%). The discharge voltage curve of the positive electrode below 3.5 V vs. Li/Li⁺ (after the first cycle) is 57 mAh/g or 23% of its capacity. This keeps the voltage of the negative electrode below 1.0 V vs. Li/Li⁺ which protects it against destructive expansion. The exemplified electrochemical cell, thus, has long life upon repeated cycling. A method of making a lithium-ion electrochemical cell is provided that includes selecting a positive electrode having a first irreversible capacity. The positive electrode includes composite particles that comprise a core comprising a layered lithium metal oxide having an O3 crystal structure, wherein if the layered lithium metal oxide is incorporated into a cathode of a lithium-ion cell, and the lithium-ion cell is charged to at least 4.6 V versus Li/Li⁺ and then discharged, the layered lithium metal oxide exhibits no dQ/dV peaks below 3.5 V vs. Li/Li⁺. The core comprises from 30 to 85 mole percent of the composite particle, based on the total moles of atoms of the composite particle. The composite particles also include a shell layer having an O3 crystal structure substantially surrounding the core, wherein the shell layer comprises an oxygen-loss, layered lithium metal oxide. The method further includes selecting a negative electrode that includes an alloy anode that has a first cycle irreversible capacity when delithiated to 0.9 V vs. Li/Li⁺ and constructing a lithium-ion electrochemical cell using an electrolyte, positive electrode and negative electrode. The first irreversible capacity of the positive electrode is less than the first irreversible of the negative electrode, the discharge voltage curve of the positive electrode covers at least 10% of its capacity at voltages below 3.5 V vs. Li/Li^{'}, when recorded in a half cell against a metallic lithium counter electrode at a rate of C/10 or slower, and displays an average discharge voltage above 3.75 V vs. Li/Li⁺ when discharged between 4.8 V vs. Li/Li⁺ and 2.5 V vs. Li/Li⁺. The electrochemical cell is discharged to a final discharge voltage of 2.5 V vs. Li/Li⁺ or greater.

Lithium-ion batteries according to the present disclosure are useful, for example, in a variety of devices, including portable computers, tablet displays, personal digital assistants, mobile telephones, motorized devices (for example, personal or household appliances and vehicles), instruments, illumination devices (for example, flashlights) and heating devices. One or more electrochemical cells of this invention can be combined to provide a battery pack. Further details as to the construction and use of lithium-ion cells and battery packs will be familiar to those skilled in the art.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All references cited in this disclosure are herein incorporated by reference in their entirety.

1. A lithium-ion electrochemical cell comprising:
a positive electrode comprising a layered lithium transition metal oxide having a first irreversible capacity; and
a negative electrode that includes an alloy anode material having a first irreversible capacity when the anode is delithiated to about 0.9 V vs. Li/Li⁺,
wherein the first irreversible capacity of the positive electrode is less than the first irreversible of the negative electrode,
wherein the discharge voltage curve of the positive electrode covers at least 10% of its capacity at voltages below 3.5 V vs. Li/Li⁺,
wherein the average discharge voltage of the positive electrode is above 3.75 V vs. Li/Li⁺ when discharged
from about 4.8 V vs. Li/Li⁺ to about 2.5 V vs. Li/Li⁺ at a rate of C/10 or slower, and
wherein the electrochemical cell is discharged to a final discharge voltage of about 2.5 V vs. Li/Li⁺ or greater.

2. A lithium-ion electrochemical cell according to claim 1 wherein the positive electrode comprises composite particles that comprise:
a core comprising a layered lithium metal oxide having an O3 crystal structure,
wherein if the layered lithium metal oxide is incorporated into a cathode of a lithium-ion cell, and the lithium-ion cell is charged to at least 4.6 V versus Li/Li⁺ and then discharged, the layered lithium metal oxide exhibits no dQ/dV peaks below 3.5 V vs. Li/Li⁺, and wherein the core comprises from 30 to 85 mole percent of the composite particle, based on the total moles of atoms of the composite particle; and
a shell layer having an O3 crystal structure substantially surrounding the core, wherein the shell layer comprises an oxygen-loss, layered lithium metal oxide.

3. A lithium-ion electrochemical cell according to claim 1, wherein the layered lithium metal oxide comprises nickel, manganese, and cobalt, and wherein the total cobalt content in the composite particle is less than 20 mole percent.

4. A lithium-ion electrochemical cell according to claim 2, wherein the shell layer is selected from the group consisting of Li[Li_{0.2}Mn_{0.54}Ni_{0.13}Co_{0.13}]O₂, Li[Li_{0.06}Mn_{0.525}Ni_{0.415}]O₂, and Li[Li_{0.2}Mn_{0.6}Ni_{0.2}]O₂.

5. A lithium-ion electrochemical cell according to claim 2, wherein the core comprises Li[Ni_{2/3}Mn_{1/3}]O₂.

6. A lithium-ion electrochemical cell according to claim 2, wherein Mn and Ni are present in the shell layer in a first molar ratio of Mn to Ni that is greater than one.

7. A lithium-ion electrochemical cell according to claim 2, wherein Mn and Ni are present in the core in a second molar ratio of Mn to Ni, less than or equal to one.

8. A lithium-ion electrochemical cell according to claim 1, wherein the positive electrode further comprises
a current collector having the positive composite particles disposed thereon,
at least one conductive diluent; and
a binder.

9. A lithium-ion electrochemical cell according to claim 8, wherein positive composite particles disposed upon the current collector have a density of greater than or equal to 2.8 grams per cubic centimeter.

10. A lithium-ion electrochemical cell according to claim 8, further comprising an anode, a separator, and an electrolyte.

11. The lithium-ion electrochemical cell according to claim 10, wherein the lithium-ion electrochemical cell is capable of being cycled with charging to at least 4.6 V versus Li/Li⁺ with a capacity fade of less than 10 percent after 100 charge-discharge cycles.

12. A method of making a lithium-ion electrochemical cell comprising:
selecting a positive electrode having a first irreversible capacity that comprises composite particles wherein the composite particles comprise:
a core comprising a layered lithium metal oxide having an O3 crystal structure,
wherein if the layered lithium metal oxide is incorporated into a cathode of a lithium-ion cell, and the lithium-ion cell is charged to at least 4.6 V vs. Li/Li⁺ and then discharged, the layered lithium metal oxide exhibits no dQ/dV peaks below 3.5 V vs. Li/Li⁺, and wherein the core comprises from 30 to 85 mole percent of the composite particle, based on the total moles of atoms of the composite particle; and
a shell layer having an O3 crystal structure substantially surrounding the core, wherein the shell layer comprises an oxygen-loss, layered lithium metal oxide;
selecting a negative electrode that includes an alloy anode that has a first cycle irreversible capacity when delithiated to 0.9 V vs. Li/Li⁺; and
constructing a lithium-ion electrochemical cell using an electrolyte, positive electrode and negative electrode,
wherein the first irreversible capacity of the positive electrode is less than the first irreversible of the negative electrode,
wherein the discharge voltage curve of the positive electrode covers at least 10% of its capacity at voltages below 3.5 V vs. Li/Li⁺, and
wherein the average discharge voltage of the positive electrode is above 3.75V when discharged from about 4.8 V vs. Li/Li⁺ to about 2.5 V vs. Li/Li+ at a rate of C/10 or slower, and
wherein the electrochemical cell is discharged to a final discharge voltage of about 2.5 V vs. Li/Li⁺ or greater.

13. A method of making a lithium-ion electrochemical cell according to claim 12, wherein the layered lithium metal oxide comprises nickel, manganese, and cobalt, and wherein the total cobalt content in the composite particle is less than 20 mole percent.

14. A method of making a lithium-ion electrochemical cell according to claim 12, wherein the shell layer is selected from the group consisting of Li[Li_{0.2}Mn_{0.54}Ni_{0.13}Co_{0.13}]O₂, Li[Li_{0.06}Mn_{0.525}Ni_{0.415}]O₂, and Li[Li_{0.2}Mn_{0.6}Ni_{0.2}]O₂.

15. A method of making a lithium-ion electrochemical cell according to claim 12, wherein the core comprises Li[Ni_{2/3}Mn_{1/3}]O₂.

16. A method of making a lithium-ion electrochemical cell according to claim 12, wherein Mn and Ni are present in the shell layer in a first molar ratio of Mn to Ni that is greater than one.

17. A method of making a lithium-ion electrochemical cell according to claim 12, wherein Mn and Ni are present in the core in a second molar ratio of Mn to Ni, less than or equal to one.

18. A method of making a lithium-ion electrochemical cell according to claim 12, wherein the positive electrode further comprises
a current collector having the positive composite particles disposed thereon,
at least one conductive diluent; and
a binder.

19. A method of making a lithium-ion electrochemical cell according to claim 12, wherein positive composite particles disposed upon the current collector have a density of greater than or equal to 2.8 grams per cubic centimeter.
